(19) United States
(12) Patent Application Publication
(10) Pub. No.: US 2021/0087763 A1
(43) Pub. Date: Mar. 25, 2021

(54) DEVICE AND METHOD FOR REMOVING OF UNWANTED MATERIAL

(71) Applicants: Phillip Island Nature Park Board of Management Inc., Phillip Island (AU); Victoria University, Footscray (AU)

(72) Inventors: John Donald Orbell, Princes Hill (AU); Stephen William Bigger, Sunbury (AU); Lawrence Ngiik Ngeh, Doncaster (AU); Matthew Lyndon Jackson, Murrumbeena (AU); Peter Michael Dann, Bass (AU); Bernard Agana, Deer Park (AU); David Roy Kay, Brighton East (AU)

(21) Appl. No.: 17/110,942

(22) Filed: Dec. 3, 2020

Related U.S. Application Data
(63) Continuation-in-part of application No. 15/761,037, filed on Mar. 16, 2018.

(30) Foreign Application Priority Data
Sep. 16, 2015 (AU) 2015903770

(51) Int. Cl. E01H 1/14; E01H 1/00; B03C 1/14; B01J 20/28; C09K 3/32; B01J 20/02

(52) U.S. Cl. CPC E01H 1/14; E01H 1/001; B03C 1/14; B01J 20/28004; C09K 3/32; B01J 20/0229; B01J 20/28009

(57) ABSTRACT

A collection kit for the removal of unwanted material from a surface, said kit comprising: iv) ferromagnetic material to absorb and/or adsorb the unwanted material when spread across the unwanted material creating an area of operation; v) an apparatus having a magnetic source operable to attract the ferromagnetic material together with absorbed and/or adsorbed unwanted material when the magnetic source is touching or in the vicinity of the area of operation; and vi) means to dislodge the ferromagnetic material and absorbed and/or adsorbed unwanted material from the apparatus once the ferromagnetic material has been removed from the area of operation.

### CROSS-REFERENCE TO RELATED APPLICATIONS

This is a Continuation-in-Part Application of U.S. patent application Ser. No. 15/761,037 filed Mar. 16, 2018, which is a 35 U.S.C. 371 National Stage Patent Application of International Application No. PCT/AU2016/050854, filed Sep. 13, 2019, which claims priority to Australian application 2015903770, filed Sep. 16, 2015, each of which is hereby incorporated by reference in its entirety.

### TECHNICAL FIELD

The present invention relates to a collection kit for the removal of unwanted material from a surface or a workplace. The kit itself includes an apparatus having a magnetic source and ferromagnetic material. In operation, the ferromagnetic material is adapted to be spread over the unwanted material so as to absorb and/or adsorb that material. The kit is operable to remove that material for disposal. The apparatus may be adapted for both domestic and/or commercial use. The unwanted material may be oils, fats, chemicals, paints, abattoir wastes, wine and other materials.

The present invention also relates to ferromagnetic material that has been specifically formulated for use with the collection kit. The ferromagnetic material of the present invention is formulated to be substantially lighter than iron powder alone, which makes it suitable for use with the preferred magnetic source apparatus.

The present invention also relates to a method for cleaning unwanted material from an area of operation which involves spreading the ferromagnetic material across the unwanted material such that the ferromagnetic material absorbs and/or adsorbs the unwanted material. The ferromagnetic material is attracted to the magnetic source and may be disposed of once the magnetic source is withdrawn from the area of operation, or the ferromagnetic material is moved from the vicinity of the magnetic source.

### BACKGROUND OF THE INVENTION

Oil spills of varying descriptions are a common occurrence in an industrialised world. The form of an oil spill varies from the somewhat catastrophic, for example as the result of oil rig or tanker accident, to everyday occurrences in the workplace or home, to the somewhat minor that may be associated with personalised oil spills from automotive engines. The manner in which such oil spills are cleaned up to any degree also substantially varies depending upon the size of the oil spill, availability of appropriate technology and immediate consequences that may have resulted from such an oil spill.

When oil spills occur in a water environment, the oil forms a thick slick that floats on the water. The oil eventually spreads out, so it is paramount to contain it as rapidly as possible allowing skimming to occur to clean up the oil slick.

An unfortunate consequence that occurs when oil spills occur in such environments is that bird and sea life become coated with the oil slick. Where possible, bird life, including penguins, may recover if the oil is removed in a prompt enough manner.

Generally, such bird life may be washed with detergents to remove the oil. This has been found to be relatively effective although the use of detergents may also have a detrimental effect upon the bird life. Further, cleansing facilities are hard to transport to remote areas.

The use of ferromagnetic material, such as gamma-iron oxide or iron powder to assist in the cleaning of wildlife has been used where the ferromagnetic material is spread onto the oiled wildlife to absorb and/or adsorb the oil and then removed by the use of a magnetic wand to remove the ferromagnetic material from the bird together with the absorbed and/or adsorbed oil. The hand-held magnetic device needs to be wiped clean to remove the oil laden ferromagnetic material.

This has proven to be an effective means to clean wildlife affected by oil spills without the detrimental effects of detergents.

U.S. Pat. No. 389,024 describes a similar process where a polymer material is used, together with a ferromagnetic material, to provide additional absorption for the oil.

Whereas the use of ferromagnetic material and a hand-held magnetic device have proven to be an effective means in which to clean oil from wildlife, such devices are not generally applicable to a broader range of situations where oil may be at issue, such as roads, home or in the workplace. Further, such devices have not been developed to clean up other types of unwarranted matter such as domestic or industrial cooking fats, paints, abattoir wastes and the like.

Other magnetic devices have been used to clean up metallic objects from roads and like surfaces, where a magnet may be swept over the surface to attract metal objects such as tacks, scrap metal or the like, that may have been spread over the surface. Such devices generally take the form of a trolley having a magnetic source as part of the underside carriage. These are adapted to attract metallic objects, and not adapted for use to clean up oil spills or the like.

It is a desired feature of the present invention to provide a magnetic collection kit that is applicable to a broad range of environments and situations, both domestically and on a commercial or industrial scale, where unwanted material such as oil spills and the like, needs to be removed and disposed of safely. Such devices may simultaneously pick up metal scraps.

It is a further desired feature of the present invention to provide a collection kit including a magnetic device that may be operated in a convenient manner where disposal of the unwanted material is relatively simple.

It is a further desired feature to provide a method for cleaning up unwanted material with a magnetic collection kit that is able to be applied to a variety of different environments.

It is a further desired feature to provide a ferromagnetic material that is formulated to be substantially lighter than iron powder yet still suitable for use with a magnetic device for the removal of unwanted material.

The present invention aims to provide a collection kit, including formulated ferromagnetic material suitable for use with the collection kit, and a method that meets these desired features.

A reference herein to a patent document or other matter which is given as prior art is not to be taken as an admission that that document or matter was known or that the information it contains was part of the common general knowledge as at the priority date of any of the claims.

Where the term “comprising” or variations thereof such as “comprises” has been used in the present specification, it will be understood to imply the inclusion of a stated integer or step or group of integers or steps but not the exclusion of any other integer or step or group of integers or steps.

### BRIEF DESCRIPTION OF THE INVENTION

The present invention relates to a collection kit that generally includes a magnetic source and ferromagnetic material that is able to one of absorb or adsorb unwanted material such as oil, fats and the like. The kit is generally operable when the ferromagnetic material is spread over the unwanted material to create an area of operation. The term, an area of operation as used herein is intended to refer to that area, such as a hard or solid surface, where unwanted material such as oil and the like has spread. The area of operation is created when the ferromagnetic material is spread over the unwanted material to absorb or adsorb that material. The collection kit is then able to remove the ferromagnetic material from the area of operation by the magnetic source. The collection kit includes a drum and the magnetic source will attract the ferromagnetic material to the outside surface of the drum. The attracted ferromagnetic material is then able to be dislodged from the drum by rotation so that the ferromagnetic material is in a place removed from the magnetic source or where there is weakened magnetic influence, and the ferromagnetic material is removed by centrifugal force, scrapping or gravity.

In a first embodiment, the present invention provides a collection kit for the removal of unwanted material from a hard or solid surface, said kit comprising:

i) ferromagnetic material to absorb or adsorb the unwanted material when spread across the unwanted material creating an area of operation;

ii) an apparatus having a drum and a magnetic source arrangement within the drum and operable to attract the ferromagnetic material together with the absorbed and/or adsorbed unwanted material to the surface of the drum when the magnetic source is touching or in the vicinity of the area of operation; and

iii) the plurality of magnets within the drum are arranged to have a stronger magnetic influence on the ferromagnetic material at an area near the area of operation and operable to attract the ferromagnetic material to the outer surface of the drum, and a lesser magnetic influence on the ferromagnetic material as the ferromagnetic material is rotated away from the area of operation.

The magnetic source itself may be housed within the drum in a fixed position such that the drum operates to rotate around the magnetic source. The magnetic source is preferably arranged to have a stronger magnetic strength operating near the area of operation. The stronger magnetic strength may for example be provided by lifter magnets which may be rare earth magnets. The stronger magnetic influence is designed to attract the ferromagnetic material to the outer surface of the drum. Preferably, carrier magnets having a lesser magnetic influence may be positioned away from the area of operation. Magnets having a lesser strength may be provided for example by ferrite ceramic magnets.

Alternatively, the magnets may be arranged such that a stronger magnetic influence is provided by placing the magnets close to the inner surface of the drum, and the magnetic influence becomes less as the magnets are placed further from the inner surface of the drum further from the area of operation or the bottom of the drum when in use.

The magnetic array is preferably suspended within the drum, the surface of which rotates around the array of magnets. The stronger magnets or the magnets positioned closer to the inner surface of the drum, are positioned to operate near the bottom of the drum when in use which is nearer the area of operation to initiate the pick-up of the ferromagnetic material. The magnets either progressively weaken the further distant from the area of operation up the side of the drum, such that there is sufficient magnetic influence to assist in carrying the ferromagnetic material to near the top of the drum, but the ferromagnetic material will be weakly bound so that it will be ejected by centrifugal force of the rotating drum near the top of rotation.

The drum may include fins to assist in picking up the ferromagnetic material. The weaker magnetic influence may be achieved through the use of weaker magnets or by placing the magnets at a further distance from the inner surface of the drum.

When the operable surface of the drum is rotated by the rolling or rotating action, the ferromagnetic material that is attracted to the surface is dislodged from the outer surface of the drum when at a location removed from the area of operation.

The ferromagnetic will become dislodged when it is no longer in the vicinity of a magnetic source or will be dislodged by scraping or simply by gravity or centrifugal force when it has rotated sufficiently. The ferromagnetic material together with any absorbed and/or adsorbed waste material may then be disposed of or recycled if appropriate.

The collection kit is particularly applicable for removing unwanted material from any surface but particularly hard or solid surfaces. The design of the collection kit will alter depending upon the type and size of surface for which it is predominantly used however the principles of the collection kit remain the same. In one preferred embodiment, the collection kit is for the removal of unwanted material from a hard surface such as a bitumen or concrete based road, work centres, benchtop, carpet, linoleum, tiles or any other hard surface for which spills are likely, including sand and rocks.

In a preferred embodiment, where ferromagnetic material has been spread over the top of some unwanted material such as oil, creating an area of operation, the magnetic source and operable surface if present are arranged so as to attract the ferromagnetic material when the device is placed near the area of operation. The device would then be operated to remove the attracted ferromagnetic material from the area of operation so that the ferromagnetic material together with the absorbed and/or adsorbed unwanted material is transferred to a collection site.

In one embodiment, the magnetic source may be fixed magnets located within the drum. The magnetic source may be arranged in a concentric wheel or part wheel within the drum and fixed in that position so as to have a magnetic influence over part of the drum. The ferromagnetic material will be attracted to the magnetic source where the magnetic source is operable through the surface of the drum.

In one embodiment, the magnets may be arranged so as to assert graduation in the magnetic field, such that the stronger magnetic influence on or through the drum is near the area of operation, that is near the surface to be cleaned. This may be achieved in a number of different ways. In one preferred embodiment, stronger magnets, such as rare earth magnets, are used at or near the area of operation. The stronger magnets here are able to attract a greater proportion of the contaminant-laden ferromagnetic material, and act as lifter magnets.

As the drum is rotated around the bank of magnets, ceramic magnets, which are not as powerful, may be positioned at stations slightly removed from the area of operation. These magnets act as carrier magnets.

As an alternative, or in conjunction, the carrier magnets may simply be positioned further away from the inner surface of the drum. This will assist in reducing the magnetic force and optimise release of the ferromagnetic material from the drum as the drum rotates. That is the lifter magnets will be positioned either touching, or close to the inner surface of the drum, while carrier magnets may also be touching but generally are positioned further away from the inner surface of the drum. It is preferred that there is at least some distance, say at least 2 mm in gap between both the lifter and carrier magnets and the inner surface of the drum. In this embodiment, the magnets may either be of the same or different types of magnets, but preferably different types of magnets.

In a preferred embodiment, the operable surface such as a drum is fitted with cups or fins on its outer surface to assist in trapping and holding the contaminant-laden ferromagnetic material. The cups or fins also assist in releasing the ferromagnetic material when combined with the centripetal force achieved with rotation of the drum. The cups or fins may be in any configuration including being rounded to form a scoop or angled forward to trap the ferromagnetic material as it lifts it from the surface. In a preferred form, the drum has fins angled at 90 degree. from the surface and of a length of 1 to 50 mm and spaced 20 to 100 mm apart. It should be appreciated however that other angles, fin sizes and spacing could be used.

In an alternative embodiment, the drum may be a stationary cylinder and the magnetic source is a concentric wheel or part wheel or a bank of magnets internal of the drum that is able to rotate within the drum. The wheel or bank of magnets may be positioned such that it has a magnetic influence over part or the whole of the drum, but is positioned so that it is able to rotate to drive the attracted ferromagnetic material around the surface of the drum until it reaches a point where the ferromagnetic material is dislodged from the surface, preferably with a scraper or the like, or more simply through gravity or centripetal force, where it is collected for disposal purposes or recycle.

In yet a further preferred embodiment, both the drum and magnetic source each rotate. The apparatus may include either a motor or appropriate gearing to drive the outer cylinder and magnetic source in the same direction, or opposite directions. In a preferred embodiment, the drum and inner wheel of magnets will rotate in the same direction but will be geared to rotate at different rates. It is believed that the speed differential may optimize the efficiency of the pick-up of the ferromagnetic material.

The drum and the concentric inner magnetic source are preferably mounted on a transport means that will allow the apparatus to be moved over the surface to be cleaned. The transport means is preferably a trolley or chassis having its own set of outer driving wheels that will allow the drum or alternative operable surface such as a rotating belt, to be moved across the area of operation. The trolley or chassis serves the purpose of maintaining the drum at an operating height above the ferromagnetic material that has been spread across the surface to be cleaned, such that the magnetic source is able to assert a magnetic influence on the ferromagnetic material and attract it to the outer surface of the drum while still being clear of the material for ease of being able to move the apparatus over the ferromagnetic material. Preferably, the drum is not at a level to touch the ferromagnetic material when spread across the contaminated area but is at a height just above that level. The trolley or chassis may have means to be able to adjust the height of the outer cylinder in operation.

In a most preferred embodiment, the outer driving wheels of the trolley rotate in the opposite direction to the drum, while the bank of magnets remains fixed. This may be achieved through appropriate gearing between the drum and driving wheels. Rotation of the drum in the opposite direction allows the ferromagnetic material to be released to a collection tray at the back of the trolley. This has the advantage that the collection tray will not interfere with the forward movement of the trolley allowing for greater access to the area to be cleaned.

A preferred gearing arrangement is such that at least one of the outer driving wheels has a gear moulded within the inner surface of that wheel. This gear engages with and turns a one-way bearing. This may include a clutch type arrangement if desired. The one-way bearing turns a smaller gear which rotates the drum in the opposite direction to the outer driving wheels when in a forward motion.

The one-way bearing will allow the drum to spin in one direction only. A brake mechanism is not needed as the friction of the gears will slow the drum as necessary. A clutch type arrangement may be incorporated to allow the drum to spin freely in the same direction (opposite the forward moving driving wheels) or remain stationary. The one-way bearing or clutch arrangement will allow the driving wheels to be able to be moved backward and forward without affecting the rotation of the drum, which will rotate in the one direction only.

Maintaining the reverse direction of the drum will allow the collection kit to continue to pick-up the ferromagnetic material and distribute it to a collection tray which is located at the rear of the trolley. The rotation of the drum should continue in a reverse direction regardless of whether the direction of the driving wheels of the trolley is in a forward or backward direction. This will allow the centripetal momentum of the rotation of the drum to continue allowing continued distribution of the ferromagnetic material to the collection tray at the rear of the trolley.

The speed of the drum or the concentric magnetic source will generally be controlled to maintain the ferromagnetic material on the surface of the drum. The rotational speed of the drum may be generated by the movement of the trolley anywhere from just below walking pace to more high speed, if for example, trailed behind a car or incorporated into a mobile device. The rotational speed may also be controlled by the internal gearing ratios and may be designed to be variable. The ideal speed of rotation will depend on factors such as the magnetic strength used, and the composition of the ferromagnetic material and the clean-up scenario.

The magnetic source may be any suitable magnets and be arranged within an array within the drum. This array will generally be in a fixed circular arrangement such that the magnets can provide a magnetic influence through the surface of the drum. Generally, the stronger magnets will be placed at the lower part of drum in operation which will be closer to the area of operation. In one preferred embodiment, these magnets will be rare earth magnets. The preferred strength of the rare earth magnets is from 1,000 to 15,000 Gauss, but preferably 3,000 to 15,000 Gauss and more preferably 5,000 to 10,000 Gauss at the surface of the magnets.

It is preferred that the magnets are arranged to provide a lesser magnetic influence away from the area of operation. The magnetic influence preferably progressively weakens removed from the area of operation. This can be achieved by placing the magnets at a distance from the inner surface of the drum or using a weaker magnet such as a ferrite ceramic magnet. If ferrite ceramic magnets are used, it is preferred that they have a magnetic strength of from 100 to 5,000 Gauss, preferably 500 to 4,000 Gauss and more preferably 500 to 3,000 Gauss at the surface of the magnets.

The collection kit may further include a trolley. The trolley will have driving wheels to move the trolley in a forward or backward direction across the area of operation and maintain the drum and magnets at a suitable operational height above the area of operation to assert a magnetic influence and attract the ferromagnetic material to the surface of the drum, yet operate so that the drum is clear of the ferromagnetic material. Preferably the drum is at a height not to touch the ferromagnetic material but can operate if it does. Preferably, the drum will operate at a height such that the lower point of the drum operates at 5 mm to 50 mm above the area of operation, more preferably 6 mm to 40 mm above the area of operation.

The trolley may include a gearing mechanism to control the rotation of the drum such that the drum is able to rotate in the opposite direction to the driving wheels when the collection kit is moved in a forward direction and remains stationary when the collection kit is moved backward. Alternatively, the gearing is such that the drum will continue to rotate in the direction that is opposite to the forward direction of the driving wheels regardless of whether the driving wheels are in a forward or backward direction. The trolley may have means to be able to adjust the height of the outer drum in operation.

The speed of the drum through rotation will generally be controlled to maintain the ferromagnetic material on the surface of the drum. This may be anywhere from just below walking pace to more high speed, if for example, trailed behind a car. The ideal speed of rotation will depend on factors such as the magnetic strength used and the composition of the ferromagnetic material.

The drums themselves may be made from any suitable material that is able to permit the magnetic source to operate through the drum and where the material from which the drum is comprised does not itself have any significant affinity for the contaminated material that is to be picked up. Suitable materials include certain plastics, stainless steel and aluminium.

In a preferred embodiment, the drum may include cups of fins on its surface to assist in lifting and carrying the ferromagnetic material.

The collection kit includes ferromagnetic material, which is preferably zero valent iron powder or a composite of zero valent iron powder with other powdered magnetic materials such as magnetite or magnetised material, preferably gamma-iron oxide particles. In one preferred form, the iron powder is combined with another material such as a non-magnetic absorbent and/or adsorbent material that will significantly reduce the weight of the ferromagnetic material when compared to iron powder alone, without significant loss of magnetic qualities.

It is preferred that the iron powder particles are spongy grade, but other grades are possible including atomised or annealed particles. The particles themselves may be course, fine or super-fine but preferably have an average particle size of between 5 and 500 microns, preferably between 5 and 200 microns, but most preferably with an average particle size of between 30 to 50 microns.

The shape of the particles is preferably irregular and the density, surface features, surface area and porosity may vary depending upon the final intended use. The ferromagnetic material is able to absorb and/or adsorb unwanted materials such as oils, fats, paints, chemicals, abattoir wastes, wine, detergents, and the like. The ferromagnetic material itself may be optimised depending upon the use to which it is likely to be put.

In a further embodiment, the present invention resides in a ferromagnetic material suitable for use with the collection kit of the invention. In this embodiment, the ferromagnetic material is preferably iron powder that has been blended or reacted with a non-magnetic absorbent and/or adsorbent material such that the non-magnetic material is able to integrate with the ferromagnetic material. The non-magnetic absorbent material may be any form of absorbent and/or adsorbent material and could include paper or plastic particles or commercial products including clays and zeolite-based products for example, a kitty litter type product. Most preferably, the non-magnetic absorbent material is a zeolite product.

The blending or reacting of the ferromagnetic material with the non-magnetic material may be in any ratio, dependent upon the need. For example, it may be in a volume ratio of from 5% to 95% ferromagnetic material with 5% to 95% nonmagnetic material, dependent upon the particular application but such that the non-magnetic material is sufficiently integrated with the ferromagnetic material to also be attracted to the magnetic source and achieving an effective contaminant absorption and/or adsorption. Preferably, a relatively even volume ratio of between 40% to 60% of each material is used, and most preferably in an approximately equivalent ratio by volume.

The benefit of blending or reacting a non-magnetic absorbent material is that the ferromagnetic material itself may not satisfactorily pick up oil from a surface. In some circumstances the non-magnetic material, such as zeolite, may not bind sufficiently to the iron powder, even in the presence of oil. It is now considered by the Applicants that the efficiency of blending a non-magnetic material with the ferromagnetic material is improved if the non-magnetic material, such as a zeolite-based product is soaked, for example in a solution of, for example ferric chloride or other salts, so as to impart a charge to the zeolite. Preferably, the zeolite material is soaked in a saturated aqueous solution of ferric chloride for several days for maximum absorption and/or adsorption of ions onto or into the zeolite.

A period of anywhere from 12 hours to 5 days may occur, preferably 2 days to 4 days. The resulting material may then be filtered and oven dried at around 50° C. to 70° C. The resultant charge on the non-magnetic material assists it in being integrated with the ferromagnetic material allowing for a consolidated blend such that the blend itself will be attracted to the magnetic 20 source.

It is believed that a modified zeolite of this type has a greater attraction for the surface of the iron particles forming a more coherent blend. For a 50/50 blend of the treated (charged) zeolite with iron powder, a significant improvement in the integrity of the mixture was observed upon oil pick-up. Furthermore, most of the oil could be harvested from this blend.

Further, the zeolite/iron powder blend is significantly lighter than the iron powder alone. A weight reduction of up to 65% may be achieved without significant loss of magnetic character.

The non-magnetic absorbent and/or adsorbent material may take any form and would include such material as absorbent and/or adsorbent clay; zeolites; aluminium silicates and minerals; recycled waste wood products; paper products; grain by-products or other naturally occurring absorbent material such as pelletised corn cobs or wheat grass or straw products. Preferably, the nonmagnetic material includes paper, clays and zeolite products. Most preferably the non-magnetic material is a modified zeolite where the characteristics of the zeolite have been modified by soaking the zeolite in a ferric chloride solution or other salts. The particle size of the non-magnetic material depends upon the material which is used but may vary from 5 microns to 100 microns and then blended or reacted with the ferromagnetic material. The blended or reacted material may be subject to grinding to achieve particle-size consistency.

In a further preferred embodiment, the collection kit also includes a container able to house the ferromagnetic material prior to spreading the ferromagnetic material. Preferably, it is housed at a temperature at or above about 14° C. as it has been found that there is better absorption and/or adsorption if the ferromagnetic material is maintained at these temperatures. Further, the container may be adapted to include a means for spreading the ferromagnetic material to obtain a relatively even coverage over the unwanted material.

In a further embodiment, the present invention also relates to a method for cleaning unwanted material from a surface, said method comprising the steps of:

i) spreading and mixing a ferromagnetic material on or across the unwanted material to form an area of operation, the ferromagnetic material being able to preferentially absorb and/or adsorb the unwanted material;

ii) collecting the ferromagnetic material with an apparatus having a drum and a magnetic source and operable to attract the ferromagnetic material and the absorbed and/or adsorbed unwanted material when the magnetic source is touching or in the vicinity of the area of operation; and

iii) the magnets within the drum are in a fixed position and arranged to have magnets having a stronger magnetic influence near the area of operation to attract the ferromagnetic material to the outer surface of the drum, and magnets having lesser magnetic influence at an area away from the area of operation.

Preferably the method includes the steps of collecting the ferromagnetic material from a particular location by attracting the ferromagnetic material to the magnetic source that is touching or in the vicinity of the area of operation.

The ferromagnetic material is then removed from the surface of the drum by scraping or by centrifugal force or gravity and the ferromagnetic material ladened with the absorbed and/or adsorbed unwanted material removed or recycled.

The collection device is useful for cleaning up oils and it is anticipated that it will also be useful for cleaning up fats, paints, chemicals, abattoir wastes, wine, detergents or any other material that is able to be adsorbed and/or absorbed by the ferromagnetic material.

### Brief Descriptions of the Drawings

FIG. 1 shows the device set up as a trolley showing the inner workings of the device.

FIG. 2 shows one arrangement of the magnet array.

FIG. 3 shows an alternative trolley type device arrangement.

FIG. 4 shows the embodiment of FIG. 3 from a front orientation.

FIG. 5 shows a cross-sectional view of the Section A-A from FIG. 4.

FIG. 6 illustrates an alternative embodiment that includes a rotating drum. FIG. 7 illustrates an alternative embodiment where cups are included to assist with the transfer of the ferromagnetic material.

FIGS. 8 to 11 show a blend of the ferromagnetic material together with a modified zeolite demonstrating how the material absorbs and/or adsorbs oil and may be removed by a magnet.

### DETAILED DESCRIPTION OF THE INVENTION

The present invention is described with reference to the accompanying drawings. It is to be understood that these drawings are merely illustrative of preferred embodiments, and the invention as described and claimed herein should not be considered to be limited thereto.

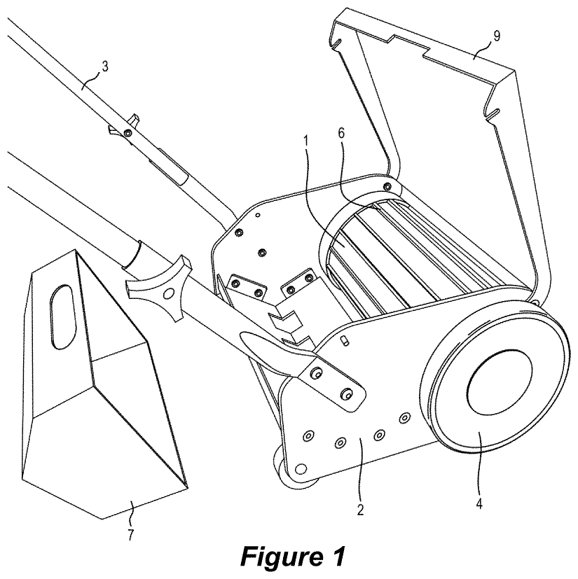

The present invention is described with reference to FIG. 1. In this embodiment, the drum (1), is housed within a trolley (2), having handles (3) to allow it to be moved. The trolley includes driving wheels (4), which are operable to move the trolley in a forward or reverse direction. The drum in this embodiment, includes fins (6) to assist in the pick-up of ferromagnetic material.

The trolley device includes gearing associated with the driving wheels and drum (not shown), which is operable to control the rotation of the drum so that it rotates in the direction opposite to the forward movement of the trolley. The gearing may be such that the drum continues in this reverse rotation even when the trolley is moved in a backward direction, or the drum will remain stationary if the trolley moves in a backward direction.

The trolley device includes a bucket (7) to catch the ferromagnetic material when it is ejected from the drum. It will sit within the trolley in use. The ferromagnetic material (not shown) will be ejected from the surface of the drum, mainly by centrifugal force following the rotation of the drum. The trolley also includes a lid (9) to assist in keeping the ferromagnetic material within the trolley when in use.

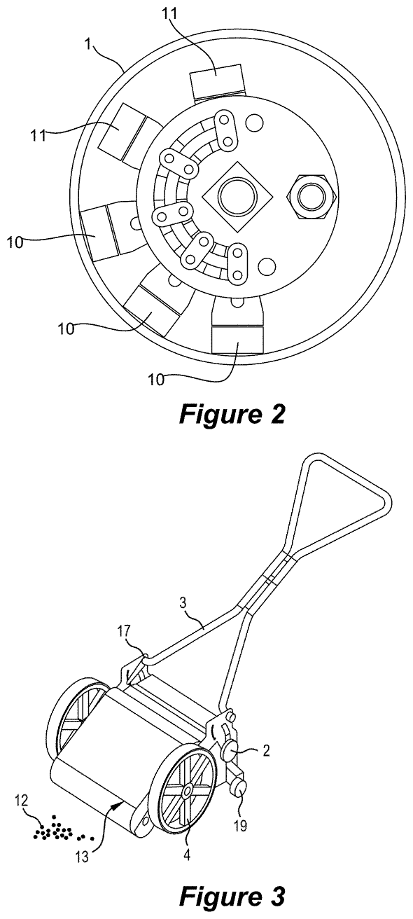

FIG. 2 illustrates the internal working of drum (1). An array of magnets is illustrated with stronger, usually rare earth magnets (10) placed near the inner surface of the drum and toward the bottom of the drum in use. This will be an area close to the area of operation when the device is in use. Magnets of a lesser strength, usually ferrite ceramic (11) are placed a distant from the area of operation. As an alternate to being of a lesser strength, the magnets may be placed such that they operate at a distance from the inner surface of the drum as show in this Figure. The purpose is to provide a graduation in the magnetic strength such that the drum can carry the ferromagnetic material up the side of the drum and eject the ferromagnetic material when the ferromagnetic material reaches the top.

In an alternative embodiment, FIG. 3 illustrates a collection kit with a trolley (2) with a handle (3) with driving wheels (4) to allow the trolley to be moved either in a forward or reverse direction. Ferromagnetic material (12) has been spread across a surface that is covered with unwanted material that creates the area of operation. The unwanted material may for example be oil but could be fats, paints, chemicals, abattoir wastes, wine, detergents or any other material able to be adsorbed and/or absorbed by the ferromagnetic material. Spreading the ferromagnetic material over the unwanted material allows for the ferromagnetic material to adsorb and/or absorb the unwanted material.

In this embodiment, the drum is replaced with an operable surface that is a collection belt (13) which is operated by belt wheels (14) (see FIG. 5) to drive and rotate the collection belt.

Ferromagnetic material (12) is placed over the spilled unwanted material to be absorbed and/or adsorbed by the ferromagnetic material. In use, the trolley type device will roll over the ferromagnetic material that has been spread over the unwanted material such that the collection belt operates just above the ferromagnetic material, while the driving wheels (4) run on the surface to be cleaned.

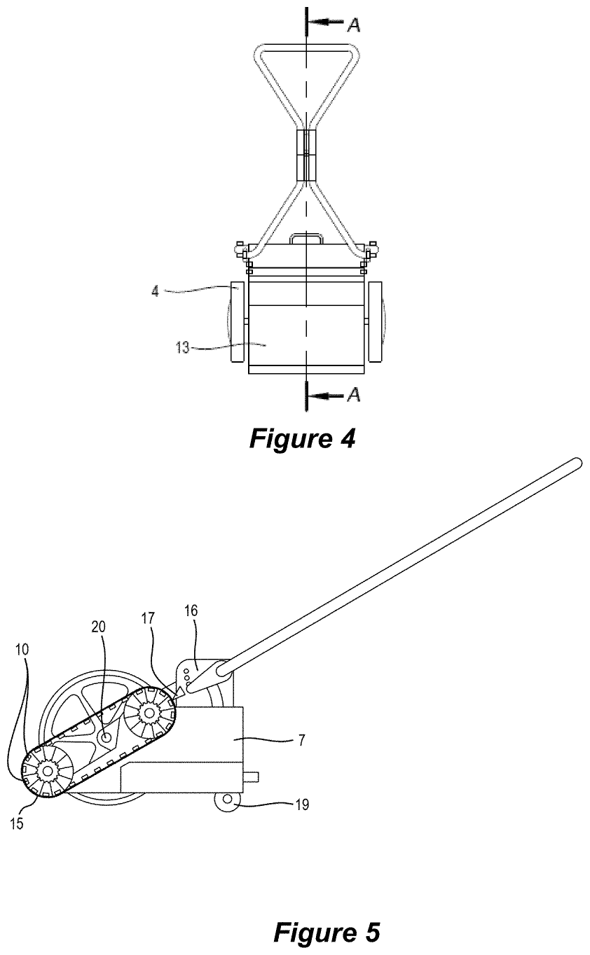

FIG. 4 shows a front view of the trolley type device with line A-A illustrating the cut through section which is illustrated in FIG. 5 and illustrating the collection belt (13) and driving wheels (4).

In the cut through illustration of FIG. 5, the magnets (10) can be seen and are affixed to a portion of the collection belt so that approximately a third of the collection belt is magnetically functional. The amount of the collection belt that becomes magnetically functional is simply a matter of design and can vary. The magnets may rotate with the collection belt or could be fixed in position.

When the magnets are in the lower position (15), they are able to attract the ferromagnetic material that has been spread over the unwanted material (not shown), such as oil, to the collection belt. The ferromagnetic material rotates with the collection belt as the belt wheels and magnets rotate. The ferromagnetic material remains on the belt wheel until it reaches point (16) where cleaning bristles (17) will remove the ferromagnetic material together with the absorbed and/or adsorbed unwanted material which then falls into the collection tray (7). The collection tray is removable for disposal of the ferromagnetic material and waste product.

The collection belt together with the magnets continues to be rotated and collect further ferromagnetic material together with the adsorbed and/or absorbed unwanted material.

Stability casters (19) may also be provided. There is also a gear box assembly (20) that allows rotation of the main driving wheels to translate the rotation of the belt wheels and hence the rotation of the collection belt.

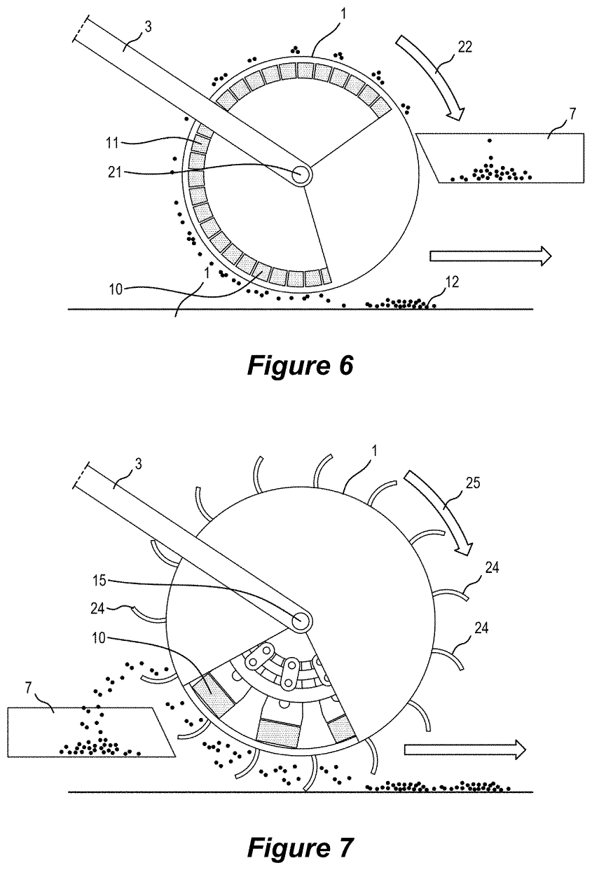

FIG. 6 shows an alternative embodiment that includes a handle (3) together with a drum (1) and an inner fixed wheel of magnets (10 and 11). The rotating drum is able to rotate around axle point (21) while the fixed wheel of magnets remains fixed and so does not rotate with the drum. The strength of the magnets will transition from the stronger magnets which operate near the lower surface of the drum to weaker magnetic strength near the upper inner surface of the drum in operation. The magnets may alternatively be positioned further from the inner surface of the drum. The apparatus will usually include a trolley or chassis (not shown) to maintain the rotating drum at a height just above the surface to be cleaned. The trolley or chassis may have its own set of wheels to allow for the apparatus to be readily rolled over the surface to be cleaned.

The apparatus is able to be rolled over ferromagnetic material (12) such that the ferromagnetic material will be attracted to the magnets and will become fixed to the rotating outer surface of the drum when in the vicinity of the magnets. The rotating drum will rotate in the direction of arrow (22) while the wheel of magnets will remain in a fixed position.

The apparatus may include a motor and gearing mechanism (not shown) to control the direction and rate of rotation of the rotating drum. The ferromagnetic material will be dislodged from the rotating outer drum when it is no longer in the vicinity of the magnets and will fall into collection tray (7).

A further embodiment is shown in FIG. 7 where the rotating drum (1) includes cups (24) able to assist in collection of the ferromagnetic material (12). The ferromagnetic material is again dislodged from the rotating drum when no longer in the vicinity of the magnets (10) into collection tray (7). The magnets remain in a fixed position while the rotating drum is able to rotate in direction of arrow (25) providing a forward motion for the apparatus.

In a comparable arrangement, both the outer drum and inner magnetic source may be geared to rotate either in the same direction or in opposite directions and at the same or differing speeds. The apparatus may be designed to allow for variation in the set-up of the movement, both direction and speed, of the outer drum on the inner concentric magnetic source dependent on the need.

### EXAMPLE 1

The zeolite used was commercial grade “SpillZorbe”.

The iron powder was supplied by Höganäs AB Grade MH300.29 spongy 5 annealed superfine (average particle size 37 microns).

A quantity of the zeolite material was soaked in a saturated aqueous solution of ferric chloride, FeCl₃, allowing several days for maximum absorption and/or adsorption of ions into the zeolite to occur. The resulting material was then dried in an oven (to constant weight) at around 60° C. This is referred to as the “modified zeolite”.

The modified zeolite was ground to a finer powder using a mortar and pestle and intimately mixed (with stirring) with an equivalent amount (by solid volume) of the iron powder.

A vigorous exothermic solid-state reaction ensued and appeared to be complete after several hours. This reaction appeared to produce two products: (1) a dark, rusty-brown product that is highly magnetic and around 26% lighter than the iron powder (on a solid volume basis) and (2) a dark yellow powder that is slightly magnetic and that is 65% lighter than the iron powder. Due to their differences in magnetic susceptibility, products (1) and (2) could be magnetically separated from one another.

### EXAMPLE 2

To make a Mark II version that is 50% lighter than the iron powder, product (1) and product (2) from Example 1 were recombined in equivalent proportion by solid volume and the mixture was ground using a mortar and pestle to produce a grey-brown powder. This blend is 50% lighter than the original pure iron powder and appears to be equally effective.

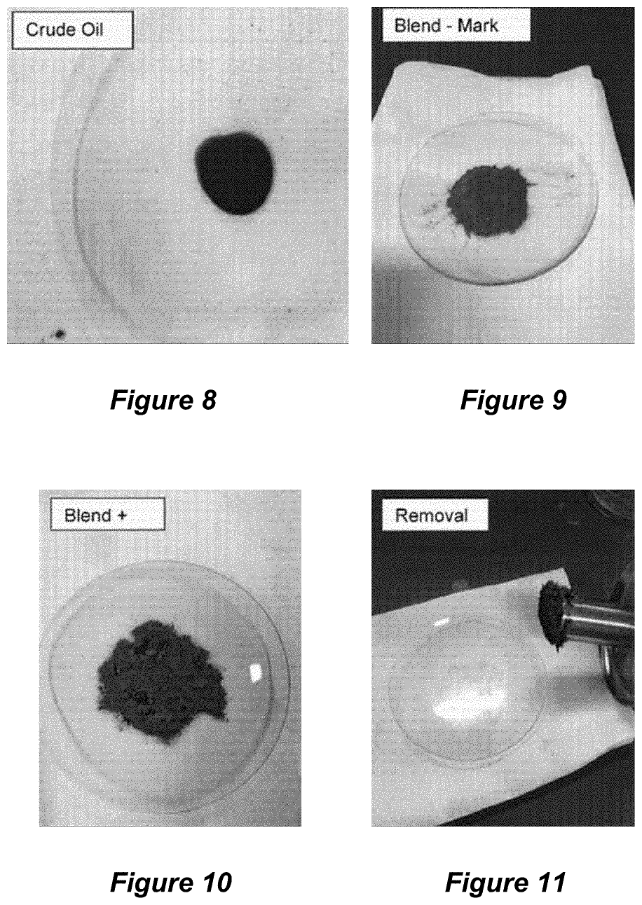

The effectiveness of this blend is shown in FIGS. 8 to 11 where FIG. 8 is crude oil in a petri dish. FIG. 9 illustrates the Mark II blend spread across the crude oil. In time, the ferromagnetic material of Mark II will absorb and/or adsorb the crude oil, as shown in FIG. 10. FIG. 11 demonstrates how ferromagnetic material, with the absorbed and/or adsorbed oil will be attracted to a magnet and removed from the contaminated area.

The invention described herein is illustrative of the invention and provides examples of the best method of performing the invention. The invention described should be considered to be inclusive of minor modifications that may be made without departing from the spirit or ambit of the invention described.

1. A collection kit for the removal of unwanted material from a hard surface or a solid surface, said collection kit comprising:
i) ferromagnetic material to at least one of absorb or adsorb the unwanted material when spread across the unwanted material creating an area of operation;
ii) an apparatus having a drum and a magnetic source arrangement including a plurality of magnets within the drum and operable to attract the ferromagnetic material together with the at least one of absorbed or adsorbed unwanted material to an outer surface of the drum when the magnetic source is in a vicinity of the area of operation; and
iii) the plurality of magnets within the drum are arranged to have a stronger magnetic influence on the ferromagnetic material at an area near the area of operation and operable to attract the ferromagnetic material to the outer surface of the drum, and a lesser magnetic influence on the ferromagnetic material as the ferromagnetic material is rotated away from the area of operation.

2. A collection kit according to claim 1 wherein at least one magnet of the plurality of magnets is positioned closer to the area of operation at a first distance from the inner surface of the drum and at least one magnet is positioned at an area removed from the area of operation at a second distance from the inner surface of the drum greater than the first distance, the magnets configured to provide a progressive weakening of a magnetic influence of the plurality of magnets as the ferromagnetic material that is attracted to the outer surface of the drum is rotated away from the area of operation.

3. A collection kit according to claim 1 wherein the plurality of magnets is in a fixed position and includes one or more lifter magnets having a first magnetic strength near the area of operation and one or more carrier magnets having a second magnetic strength less than the first magnetic strength positioned at a distance removed from the area of operation.

4. A collection kit according to claim 3 wherein the one or more lifter magnets are rare earth magnets and the one or more carrier magnets are ferrite ceramic magnets.

5. A collection kit according to claim 1 further comprising a gearing mechanism operatively coupled to the drum and the magnetic source arrangement and configured to control rotation of the drum and the magnetic source arrangement, wherein the drum or the magnetic source arrangement housed within the drum is configured to rotate while the other is stationary; or the drum and the magnetic source arrangement are configured to rotate in a same direction or a different direction and at a same rate or a different rate.

6. A collection kit according to claim wherein the ferromagnetic material is a zero valent iron particle material or a composite of zero valent iron powder with gamma-iron oxide particles and is blended with a non-magnetic absorbent material that has been subsequently magnetized or imparted with an electric charge.

7. A collection kit according to claim 6 wherein the nonmagnetic absorbent material is selected from at least one of zeolites, absorbent clay, adsorbent clay, aluminium silicates and minerals, recycled waste wood, paper products, grain by-products, plastic particles or other naturally occurring absorbent and/or material or adsorbent material.

8. A collection kit according to claim 1 wherein the ferromagnetic material is housed in a container that is able to maintain a temperature of the ferromagnetic material at or above 14° C., and a device to aid in spreading the material.

9. A collection kit according to claim 4 wherein the one or more lifter magnets have a magnetic strength of from 1,000 Gauss to 15,000 Gauss at a surface of the one or more lifter magnets and the one or more carrier magnets have a magnetic strength of 100 Gauss to 5,000 Gauss at a surface of the one or more carrier magnets.

10. A collection kit according to claim 1 wherein the drum is positioned to operate at a distance of 5 mm to 50 mm above the surface of the area of operation and includes a plurality of cups or a plurality of fins on the outer surface of the drum to assist in lifting and carrying the ferromagnetic material.

11. A collection kit according to claim 1 further comprising a trolley having driving wheels to move the trolley in a forward direction or a backward direction, and including a gearing mechanism to control a rotation of the drum such that the drum rotates in an opposite direction to the driving wheels when the collection kit is moved in a forward direction and remains stationary when the trolley is moved backwards or is geared such that the drum will continue to rotate in the opposite direction to the forward motion of the driving wheels regardless of whether the driving wheels are moved in the forward direction or the backward direction.

12. A collection kit according to claim 9 wherein the zero valent iron powder includes a plurality of spongy grade, atomized, or annealed particles having an average particle size of 5 microns to 100 microns.
